(19) United States
(12) Patent Application Publication
(10) Pub. No.: US 2004/0094848 A1
(43) Pub. Date: May 20, 2004

(54) Gas eductors and gas eductor flotation separators

(76) Inventor: Neville Ernest Lange, Gloucester (GB)

Correspondence Address: YOUNG & THOMPSON, 745 SOUTH 23RD STREET 2ND FLOOR, ARLINGTON, VA, 22202

(21) Appl. No.: 10/631,822

(22) Filed: Aug. 1, 2003

Related U.S. Application Data
(60) Provisional application No. 60/406,667, filed on Aug. 29, 2002.

(30) Foreign Application Priority Data
Aug. 1, 2002 (GB) 0217807.7

(51) Int. Cl. B01D 47/00; F24F 3/14; C10K 1/08; F02M 1/00

(52) U.S. Cl. 261/59

(57) ABSTRACT

Eductor apparatus is provided for introducing gas bubbles into a contaminated liquid in a gas flotation cell, the apparatus comprising a clean liquid inlet port, the inlet port having an outlet end (104) through which the clean liquid is ejected in a first direction, a gas inlet chamber adjacent to the outlet end of the inlet port for introducing gas to the liquid from a gas inlet port, the gas inlet chamber substantially surrounding the flow of liquid when the apparatus is in use, and a gas/liquid mixing and diffusing section wherein gas is entrained within the liquid prior to being ejected from the eductor apparatus into the contaminated liquid, the gas/liquid mixing and diffusing section having a direction of fluid flow substantially transverse to the first direction such that the fluid exits from the gas/liquid mixing and diffusing section substantially radially outwardly relative to the first direction.

The present invention relates to gas eductors and induced gas flotation separators.

### BACKGROUND OF THE INVENTION

In the oil and waste water industries a process known as “flotation” is commonly used to assist in the removal of oil and other contaminants from water. The principle of flotation is that bubbles of gas are introduced into or generated in a vessel containing a contaminated water, in which the bubbles will to a greater or lesser degree attach to the contaminants and drag them to the surface of the water, leaving the bulk of the water depleted of contaminants, and the upper layers of the water enriched with the contaminants. In subsequent discussion each volume of water to which gas bubbles are added to separate contaminants is called a “cell” or “flotation cell”.

Flotation is usually operated as a continuous process, where there is a continuous inflow of contaminated water into the cell and a continual outflow of contaminant enriched water drawn from the surface layers of the cell and a continual outflow of the contaminant depleted water drawn from the cell at a rate so as to maintain an essentially constant level in the vessel.

It is usual for the contaminants floated to the surface of the water to be retained in a froth which is either formed naturally when the contaminants are present at the higher concentrations found at the water surface, or with the assistance of chemicals which are added to the inflowing liquid. Buoyant contaminants, for example droplets of oil, may not need to be frothed to keep them at the surface.

The contaminants on the water surface are removed by a variety of means, the two most common being weirs set slightly below the water surface so that the contaminant enriched surface layer preferentially flows over them, or paddles which sweep the contaminant enriched surface layer over a weir which is normally set slightly above the water surface. A number of designs of floating skimming devices are also known which have the advantage that they can tolerate a wider variation in operating liquid level than either of the aforementioned fixed weir methods can accommodate.

The gas bubbles which cause the flotation are commonly generated or introduced by two methods, called “dissolved gas flotation” and “induced gas flotation”.

In dissolved gas flotation a flow of water, usually contaminant depleted water taken from the cell outlet, is contacted with the gas at an elevated pressure, so that gas in a quantity in excess of that which would saturate the water at the pressure in the flotation cell dissolves in the flow. The flow is then reintroduced into the cell with its pressure being reduced close to the point of its reintroduction into the cell. After the pressure reduction the flow is supersaturated with gas, and the excess gas comes out of solution in the form of bubbles. This method of bubble generation produces relatively small bubbles, typically 50 to 70 microns in diameter, which rise quite slowly and the cell therefore has to be designed to have minimal turbulence and mixing, and low fluid velocities, so that the rise of the bubbles is not inhibited. It is also important that gas bubbles are evenly distributed through the contaminated water to maximise the quantity of the contaminant that is removed, but because turbulence and mixing is intentionally minimised in the cell this must be achieved by careful design of the contaminated water flow path and the way in which the flow containing the excess dissolved gas is reintroduced into the cell. In a properly designed cell the multitude of small bubbles are very effective in separating contaminants and the minimal turbulence and mixing results in their being minimal mixing and hence contamination of the fluid through which the bubbles have passed by the inlet fluid, so that a high efficiency of removal of the contaminants can be achieved in a single cell.

In induced gas flotation the gas is drawn into the water by mechanical or hydraulic means, and the resulting processes are called mechanical induced gas flotation or hydraulic induced gas flotation respectively.

To provide the gas bubbles in mechanical induced gas flotation, a mixer is inserted into the cell and a vortex forms above it through which gas is drawn down to the impeller of the mixer. The gas is broken into bubbles and expelled from the mixer in a generally radial direction along with the water, which the mixer also pumps. The bubbles are distributed through the fluid in the cell by the rapid circulation caused by the mixer.

To provide the gas bubbles in hydraulic induced gas flotation a flow of water is taken from the cell, usually contaminant depleted water taken from the cell outlet, is pressurised by a pump and then returned into the cell through an eductor which draws gas into the flow. The cell usually has impingement plates or similar devices onto which the returning flow is directed to improve the distribution of the returning flow and the gas bubbles it contains. As with mechanical induced gals flotation, mixing is necessary to distribute the bubbles in the fluid in the cell. Mixing is caused by the momentum of the returning flow and because the bubbles are not uniformly distributed gas lift also occurs in the regions of high bubble concentration which causes further mixing or circulation.

Both mechanical and hydraulic means produce bubbles that are significantly larger than those produced by dissolved gas flotation, and both processes have significant mixing in the cell. For a given quantity of gas, increasing the bubble size reduces the efficiency of contaminant removal because it makes fewer bubbles which reside in the liquid for a shorter time due to their faster rise rate. The mixing and bubble size contribute to cell contaminant removal efficiency which is therefore much lower than is achieved in dissolved gas flotation. As a consequence, induced gas flotation processes normally incorporate a number of cells (typically 4 to 6) operating in series to provide the necessary overall contaminant removal efficiency. Induced gas flotation processes however generally have higher specific throughputs (ratio of throughput to size) than dissolved gas flotation processes and can operate with warmer waters where the reduced gas solubility of water makes a dissolved gas flotation process less practical. Dissolved gas flotation is used in wastewater and drinking water treatment where very fine contaminants are agglomerated by chemical flocculants before entering the cell. Induced gas flotation is unsuitable for this application because the agglomerates are quite fragile and would be broken up by the mixing and turbulence in the cells.

In recent years another configuration of flotation process has become popular for applications in the offshore oil industry. It consists of a single flotation cell, generally a vertical cylindrical cell, with an eductor to provide the gas bubbles. The predominant application of these cells is to at least partially remove residual oil from produced water exiting liquid/liquid hydrocyclones before it is discharged into the sea. The large bubble size and degree of mixing inherent in induced gas flotation processes means that these cells do not have a high efficiency. As the amount of oil that is permitted to be present in produced water discharged to the sea is being reduced around the world, it would be desirable to improve the oil removal efficiency of these units.

In most hydraulic induced gas flotation process it would be of economic benefit to improve the contaminant removal efficiency.

Embodiments of this invention are intended to provide an improved eductor for hydraulic induced gas flotation which can produce finer bubbles than conventional eductors and which can distribute the gas bubbles within an induced gas flotation cell with less mixing so that the efficiency of contaminant removal can be increased.

### SUMMARY OF THE INVENTION

According to a first aspect of the present invention there is provided eductor apparatus for introducing gas bubbles into a contaminated liquid in a gas flotation cell, the apparatus comprising a clean liquid inlet port, the inlet port having an outlet end through which the clean liquid is ejected in a first direction, a gas inlet chamber adjacent to the outlet end of the inlet port for introducing gas to the liquid from a gas inlet port, the gas inlet chamber substantially surrounding the flow of liquid when the apparatus is in use, and a gas/liquid mixing and diffusing section wherein gas is entrained within the liquid prior to being ejected from the eductor apparatus into the contaminated liquid, the gas/liquid mixing and diffusing section having a direction of fluid flow substantially transverse to the first direction such that the fluid exits from the gas/liquid mixing and diffusing section substantially radially outwardly relative to said first direction.

By “clean liquid” is meant clean by comparison to the contaminated liquid and may be, for example, previously decontaminated and re-cycled liquid from the flotation cell.

Preferably, the inner wall of the eductor between the gas inlet chamber and the transition of fluid flow from the first direction to the second direct are curved towards the second direction, the curve providing a smooth change of direction of flow of gas prior to it entering the gas/liquid mixing and diffusing section to then mix with, and become entrained in, the liquid prior to the resultant composition exiting the eductor. In this region, the body of the eductor may therefore be shaped substantially like an open end of the inside of a flared bell whose inner wall then continues in the transverse direction from what would be the outer lip of the open end as an inner, upper, wall member relative to the major axis of the downwardly disposed outlet end of the liquid inlet port.

Conveniently, the mixing and diffusing section is located at least partially in a space defined by the upper wall member adjacent to the gas inlet chamber and a lower wall member, which can be in the form of an impingement plate for the liquid disposed substantially opposite thereto.

The mixing and diffusing section can be generally annular such that the bubbles emanating from the eductor can emanate substantially radially.

The impingement plate may be connected to the body of the eductor by means of a plurality of studs, the studs possibly being fitted through a flange projecting from the eductor. In one embodiment, at least part of the outer surface of the outlet portion of the eductor may be cut away so that the distance between the outlet portion and the impingement plate may be varied with increasing radial distance from the area of the impingement plate onto which the liquid is initially directed. Alternatively or additionally, at least part of the surface of the impingement plate facing the outlet portion may be cut away in a similar manner.

Conveniently the impingement plate is of greater diameter than the upper wall member.

The impingement plate may be provided with discontinuities on its surface for regulating the distribution of bubbles dissipating from the gas entrained liquid, such as by providing apertures therein.

The discontinuities may also be provided by raised formations on the impingement plate, such as bolt heads or plates secured to the impingement plate and arranged transversely to the direction of flow.

According to a second aspect of the invention there is provided a gas eductor induced gas flotation separator including one or more gas introducing chambers for bringing a gas entrained liquid into contact with a contaminated liquid such as water by means of gas eductors, where contaminants in the liquid are floated to the surface of the liquid by attaching to gas bubbles emanating from said gas entrained liquid, each said eductor having a mixing and diffusing section substantially transverse to the axis of flow of the liquid entering the eductor, the eductor further including a channel section leading from the gas introducing chamber to the mixing and diffusion section, the channel section including:

an inlet portion adjacent to the gas introducing chamber;

an outlet portion adjacent to the mixing and diffusion section, and an intermediate portion located between the inlet and outlet portions, the diameter of the intermediate portion being less than the diameter of the inlet portion, and the diameter of the outlet portion being greater than the diameter of the intermediate portion.

Conveniently, the inner wall of the channel section between the inlet portion and the intermediate portion is substantially frusto-conical in shape and may be shaped substantially like an open end of a flared bell.

Conveniently, the inner wall of the channel section between the intermediate portion and the outlet portion is also substantially frusto-conical and may be shaped substantially like an open end of a flared bell.

The mixing and diffusing section may be located at least partially in a space defined by an outer surface of the outlet portion and an impingement plate fitted substantially transverse to the flow of liquid entering the eductor and adjacent the outlet portion and may be generally annular.

The impingement plate may be fitted and spaced apart from the separator by a plurality of studs, which may extend through a flange projecting fom the channel section.

At least part of the surface of the impingement plate facing the outlet portion may be cut away so that the distance between the outlet portion and the impingement plate is varied, and the distance between the outlet portion and the impingement plate may generally increase with increasing radial distance from the point on the impingement plate where the jet is directed.

According to a third aspect of the present invention there is provided apparatus such as an eductor for mixing a gas with a liquid and diffusing the mixture, the apparatus including:

one or more gas introducing chambers for bringing a gas into contact with a liquid:

a mixing and diffusing section substantially transverse to the axis of flow of the liquid entering the eductor, and

a channel section leading from the gas introducing chamber to the mixing and diffusing section, the channel section including:

an inlet portion:

an outlet portion adjacent to the mixing and diffusing section, and

an intermediate portion located between the inlet and outlet portions, the diameter of the intermediate portion being less than the diameter of the inlet portion, and the diameter of the outlet portion being greater than the diameter of the intermediate portion.

The eductor may further include a nozzle component for producing a jet of liquid directed generally towards a said gas introducing chamber.

According to a fourth aspect of the present invention there is provided apparatus for mixing a gas with a liquid and diffusing the mixture, the apparatus including:

a nozzle for receiving a flow of liquid entering the eductor and producing a jet of liquid;

one or more gas introducing chambers for bringing a gas into contact with the jet of liquid;

a mixing and diffusing section being substantially transverse to the axis of the liquid flow and being defined between an outlet portion of the eductor and a body portion spaced apart from the outlet portion,

wherein the mixing and diffusing section is generally annular and has an outer diameter up to 15 times greater than the diameter of the jet issuing from the nozzle.

The body portion, which may be opposite an impingement plate arranged substantially transverse to the initial flow of liquid through the apparatus. The minimum diameter of the outlet portion is preferably as small as possible, whilst still allowing room for gas to enter the mixing and diffusing section from the gas introducing space.

The minimum diameter of the outlet portion can be less than 2 times the diameter of the jet.

The distance between the eductor outlet and the impingement plate may be between 1.5 and 6 times the depth of the liquid at the periphery of a generally circular area of the plate substantially equal in diameter to the minimum diameter of the outlet portion where it becomes substantially parallel to the impingement plate. The depth of the liquid at the periphery of the generally circular area may be calculated as: (diameter of jet)²/(4×d1), where d1 is the minimum diameter of the outlet portion where it becomes substantially parallel to the impingement plate.

Whilst the invention has been described above, it extends to any inventive combination of the features set out above or in the following description.

The invention may be performed in various ways, and, by way of example only, embodiments thereof will now be described, reference being made to the accompanying drawings, in which:

### BRIEF DESCRIPTION OF THE DRAWINGS

FIG. 1 is a cross-section through a conventional eductor;

FIG. 2 is a cross-section through an eductor according to a first embodiment of the present invention;

FIG. 3 is a view similar to that of FIG. 2 but highlighting possible modifications to the eductor;

FIG. 4 is a cross-section through a further embodiment;

FIGS. 5 to 8 are graphs illustrating the results of testing one embodiment:

FIG. 9 is a cross-section through part of the eductor being tested to produce the results shown in the graphs of FIGS. 5 to 8;

FIG. 10 is a cross-section through part of a prior art eductor, and

FIGS. 11 and 12 are graphs showing the bubble sizes produced by the eductors of FIGS. 9 & 10 respectively.

### DETAILED DESCRIPTION OF THE DRAWINGS

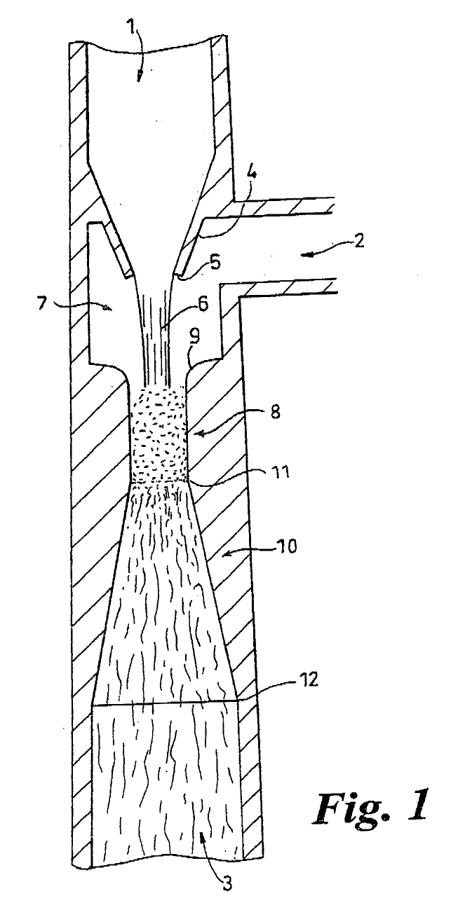

A conventional eductor is shown FIG. 1 and has an inlet port 1 for motive water, an inlet port 2 for gas, and an outlet port 3, for the combined flow of gas entrained liquid. Once inside the body of the eductor the motive water passes through a converging nozzle 4 having an outlet end 5, to produce a jet of water 6. The jet of water 6 passes through a gas inlet chamber 7 where the jet is surrounded by the gas which has entered the body of the eductor through the gas inlet port 2. The jet and gas then enter a substantially cylindrical mixing section 8. In the mixing section the motive water mixes with the gas so that a fairly uniform mixture enters a diffusing section 10 at a fairly uniform velocity. The inlet end 9 of the mixing section 8 normally has a radius or some other profile designed to reduce the resistance to the flow of gas entering the mixing section 8. The diffusing section 10 is frusto-conical, matching the diameter of the mixing section 8 at its outlet end 11 and the diameter of the outlet port 3 at its inlet end 2. The walls of the diffusing section 10 typically has an included angle of 6° to 7°, and may have a diameter at its outlet end 2 to 3 times the diameter of its inlet end, which would give a ratio of the areas of the outlet end to the inlet end of 4:1 to 9:1.

The method by which the eductor works is as follows:

I. The motive water is converted into a high velocity jet in the converging nozzle 4, turning part of its pressure energy into kinetic energy ie velocity.

II. The motive water and the gas mix together in the mixing section 10. The velocity of the mixture exiting the mixing section follows the principle of conserving the momentum of the gas and liquid streams entering the mixing section.

III. The mixture is deccelerated in the diffusing section 10 converting its kinetic energy i.e. velocity, to pressure. The ratio of the cross sectional areas at the inlet and outlet end of the diffuser 10 determine how much the flow reduces in velocity and hence how much pressure it can regain.

Bermoulli's theorem can be used to calculate the theoretical maximum conversion of pressure to velocity and vice versa occurring in the motive water nozzle 4 and the diffusing section 10 provided that suitable allowances are made for frictional losses. Due to the high velocities in the eductor, losses of energy can be rapid if the eductor is not of optimum design. ESDU International publish verified design methods for eductors which detail the important design features.

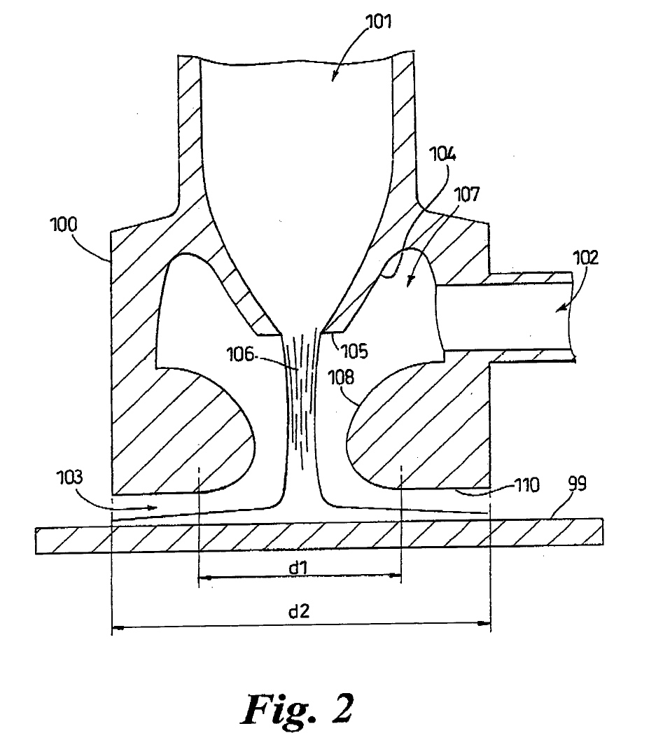

An improved eductor in accordance with the invention is shown in FIG. 2. The improved eductor body 100 is generally circular and has an inlet port 101 for motive water leading to a converging nozzle 104 having an outlet end 105 for a jet of clean liquid 106 (as defined). The eductor also has an inlet port 102 for gas to enter into a gas chamber 107, the axes two inlet ports 101 and 102 being arranged substantially perpendicular to each other. The upper portion of the gas inlet chamber 107 is generally annular, giving the outer surface of the nozzle 104 an annular shape of a generally frusto-conical profile. The lower inner wall 108 of the chamber 107 curves downwards to form an opening leading to a generally annular space defining a gas liquid mixing and diffusing section 103. The curved wall 108 leading to the opening into the mixing and diffusing section 103 is designed to reduce the resistance to the flow of gas which is drawn into the chamber 107 such that an initially thin layer of gas remains between the liquid and the upper end face or wall 110 of the eductor body 100 and a flat impingement plate 99, until the gas and water mix, the end face/wall 110 and plate 99 together defining the mixing and diffusing section 103.

It will be understood that although a flat impingement plate 99 is shown in the embodiment described herein, the invention is not so limited. For example, the jet of liquid could be directed generally towards another body such as the bottom of a generally flat bottomed vessel or even a block of material. The space defined by mixing and diffusing section 103 extends from a diameter d1 where the end face/wall 110 first becomes parallel with the impingement plate 99 to a diameter d2 equal to the diameter of the eductor body 100. Where the eductor body does not have a cylindrical exterior, diameter d2 would be taken as the smallest diameter greater than diameter d1 where the gap between the end face of the eductor and the surface is greater than 6 times the liquid film thickness at diameter d1 and the end face/wall of the eductor body first makes an angle to the surface which is larger than 20°.

In use, the motive water entering in a first direction passes from the inlet port 101 through the outlet end 105 of the nozzle 104 to produce a jet of water 106. The jet passes through the gas inlet chamber 107 where the jet is surrounded by the gas which has entered the body 100 of the eductor through the gas inlet port 102. The jet then passes through the opening defined by the annular inner wall 108 in the eductor body 100, to impinge on the flat surface of the impingement plate 99, the axis of the jet being substantially normal to the flat surface. The jet of water then spreads out in a transverse second direction substantially radially on the flat surface of the plate 99 from its point of impingement, and passes into the annular space defined by the mixing and diffusing section 103. In its passage through the mixing and diffusing section 103, the water entrains gas so that a diffused mixture of water and gas bubbles exit from the eductor body.

In comparison to the conventional eductor shown in FIG. 1, the improved eductor lacks a clearly defined mixing section and diffusing section within the eductor body 100. The function which is defined as mixing in the conventional eductor, where the flow is axial, could be considered to occur in the improved eductor where the flow is mainly radial, within some or all of the mixing/diffusing section 103. The function which is defined as diffusing in the conventional eductor, could also be considered to occur in that portion of the mixing/diffusing section 103 beyond the radius at which mixing is considered to initially occur. It is likely, however, that there is an overlap in the regions where these functions are occurring. This may be detrimental to achieving optimal performance of either function, so that the improved eductor may not draw as much gas as a conventional eductor when operated at the same pressures and motive water flow.

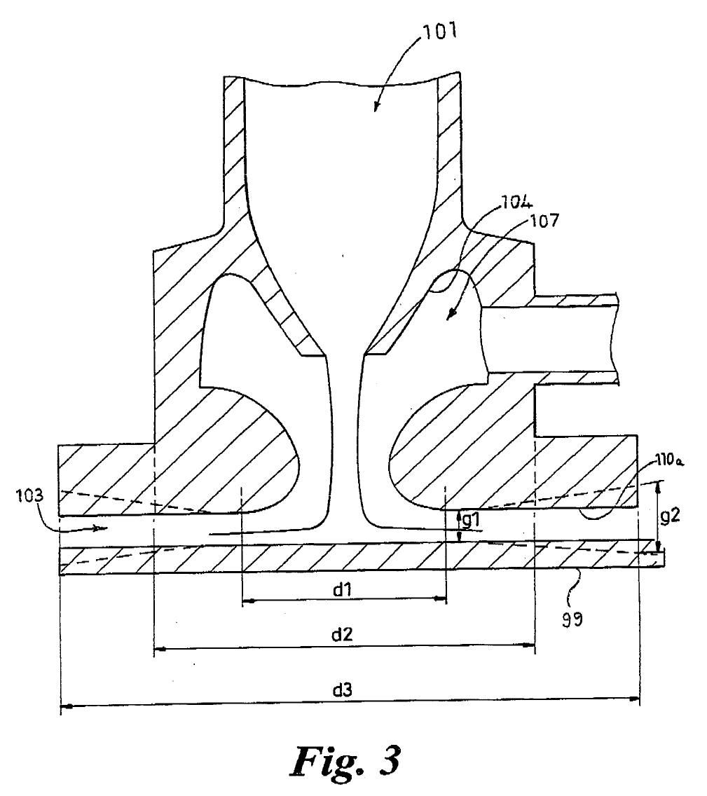

FIG. 3 illustrates how the profile and dimensions of the end face 110 of the improved eductor may be modified to provide a greater or lesser opportunity for the functions of mixing and diffusing to occur. Increasing the diameter of the endface 110 to a diameter d3 greater than diameter d2 will increase the cross sectional area through which the fluid flow exits from the mixing/diffusing section 102 between the endface 110 and the flat impingement plate 99.

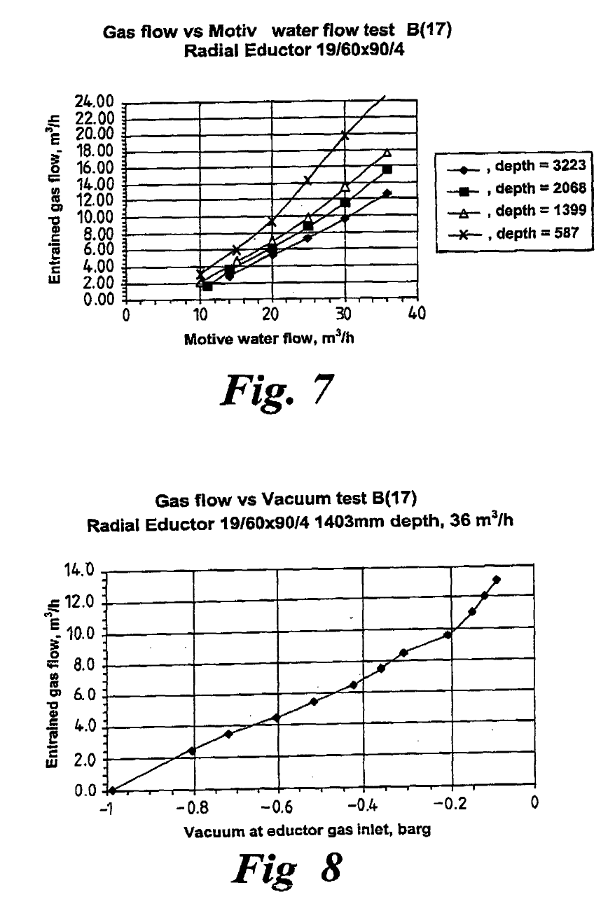

Although specific dimensions are given for an embodiment of the invention shows in FIG. 9 described below, the inventor has found that the following dimensions can result in eductors that can produce finer bubbles than conventional eductors and which can distribute the gas bubbles within an induced gas flotation cell with less mixing so that the efficiency of contaminant removal can be increased. The diameter d2 can be up to 15 times greater than the diameter of the jet issuing from the outlet end 105 of the nozzle 104. The diameter d1 is preferably as small as possible, whilst still allowing room for gas to enter the annular area from the gas introducing chamber 107 and d1 can be less than two times the diameter of the jet issuing from the nozzle 104. The thickness of the annular space defining the mixing and diffusing section 103 may be between 1.5 and 6 times the thickness/depth of the radially spreading water film at the periphery of a generally circular area on the plate 99 having a diameter d1. The depth of the film of water at the periphery may be calculated as (diameter of jet)²/(4×d1).

Providing an angle on the endface 110, or the flat plate 99 (shown in the broken outline) or both so that the gap between them is greater at the outlet end of the mixing/diffusing section 103 also increases the cross sectional area through which the flow exits. Such angles can be achieved but cutting away portions of the endface 110 and impingement plate 99 as shown by the broken lines between g1 and g2. Both modifications also increase the volume of the annular space and they may be used separately or in combination. Increasing the cross sectional area through which the flow exits from the radial eductor reduces its velocity and is analogous to providing a diffuser with a greater area ratio in a conventional eductor. It is to be noted however that the diffuser of such an improved eductor may not be particularly efficient, in that it may have flow separation from one or both walls 110, 99 but that this does not detract from the invention.

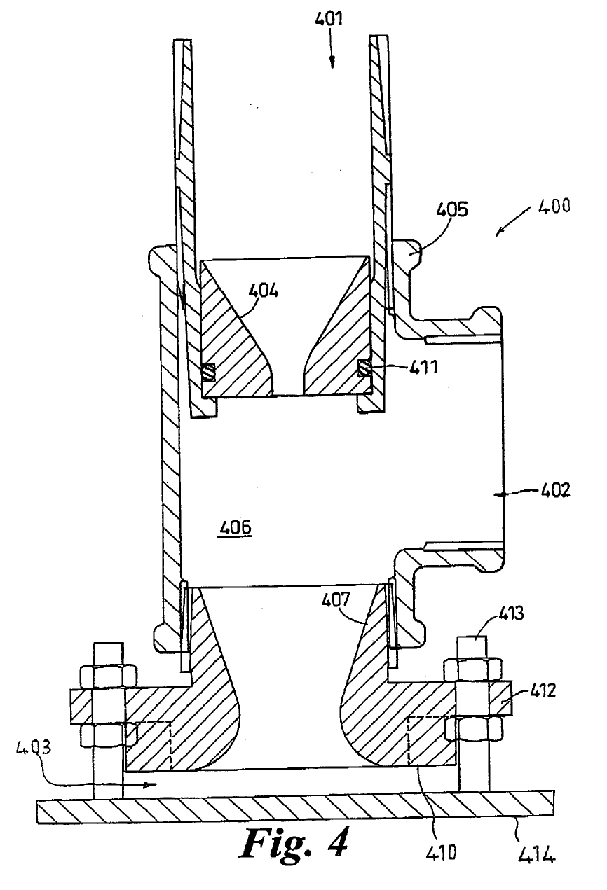

The embodiment of FIG. 4 shows an eductor body shown generally at 400 having an inlet port 401 formed as a substantially cylindrical piece. The inlet port 401 is fitted into one end of a threaded pipe tee 405. At the lower end of the inlet port 401 there is a nozzle piece 404. An o-ring 411 is fitted within an annular groove around the outside of the nozzle piece 404 and is in contact with the inner surface of the inlet port 401 to form a seal therebetween and thereby prevent motive water bypassing the nozzle 404.

The branch opening 402 of the threaded pipe tee 405 is used as an inlet port for gas. Fitted to the opening of the threaded pipe tee 405 opposite the opening containing the inlet port 401 is another eductor component in the form of an annular collar 407. The central body of threaded pipe tee 405 includes a space or chamber 406 where liquid passing through the nozzle 404 and gas passing through the gas inlet port 402 can come into contact with each other. The collar 407 is shaped at its inlet end so that it forms a substantially frusto conical funnel leading from the chamber 406. Below the narrow end of the funnel, the side walls of the collar 407 flare outwardly like a bell to then form the substantially flat, perpendicular end face/upper wall 410.

The eductor collar 407 also includes an outer flange 412 near its end face 410. The flange 412 includes apertures through which threaded studs 413 are fitted to attach a circular impingement plate 414 to the bottom of the eductor body 400. A space 403 is therefore present between the end face 410 of the eductor flange component 407 and the adjacent surface of the impingement plate 414. As described for the embodiment of FIG. 2 above, the space 403 can be used as the mixing/diffusing section of the eductor to produce initially radially emanating bubbles.

In comparison to a conventional eductor where the outlet flow of water with entrained gas therein exits in an axial direction, the outlet flow of water and entrained gas exits from the improved eductor in a substantially radial direction. This inherently provides in the eductor a means of directing the motive clean water and gas mixture into the contaminated water to effect distribution of the gas bubbles. As described above, the geometry of the end face of the improved eductor can be modified to vary the velocity of the outlet flow so that the distribution can be optimised for a particular cell geometry.

It is a first common practice where a conventional eductor is used in a hydraulic induced gas flotation cell to position the eductor so that its outlet points vertically downwards onto a horizontal impingement plate so that the flow exiting axially from the eductor hits the plate and is deflected radially outward. Placing the impingement plate close to the outlet of the eductor produces a higher radial velocity which generates a greater backpressure on the outlet of the eductor, but the higher velocity allows the gas bubbles to be distributed into the surrounding water to a greater radial distance from the eductor. To match the radial velocity that the improved eductor produces, a conventional eductor would need its impingement plate to be positioned away from the eductor outlet at a distance of approximately 0.05 to 0.15 times the diameter of the outlet. In this position most of the pressure that is recovered in the axially disposed diffusing section of the conventional eductor is used to accelerate the flow to pass through the small gap between the end of the eductor and the impingement plate.

A second common practice where a conventional eductor is used in a hydraulic induced gas flotation cell is to position the eductor in pipework which may be external to the cell, and pipe the outlet flow of gas and water into a distributor manifold within the cell. This construction is used so that the eductor can be accessed for maintenance or inspection without having to enter the cell. It may also be possible to position the eductor above the normal liquid level in the cell so that the cell does not need to be drained to remove the eductor.

When operated in a hydraulic induced gas flotation cell, it was found that the improved eductor produced a smaller bubble size than a conventional eductor mounted as described in the first common practice. In fresh water the reduction in bubble size was found to be grater than in saline water. The exact mechanism for this result is not certain but since it is known that gas bubble coalescence is slower in saline waters, it is thought to be due to the improved eductor of the invention more rapidly dispersing the gas bubbles so that they are unable to coalesce into larger bubbles. If the operation of the conventional eductor in this respect is examined it will be seen that after the bubbles are generated in the mixing section they must pass through the diffuser and then turn through an angle of 90° on the impingement plate before being dispersed into the bulk of the water in the cell. The probability of gas bubble collision, which is a precursor to coalescence therefore remains high until the bubbles are well dispersed into the bulk liquid. In the improved eductor the gas bubbles are generated in a water flow which is already radial, and the flow is diffused only to the required velocity for distribution before being introduced to the bulk of the liquid, which results in the gas bubbles having a shorter residence time in the eductor. In the conventional eductor the residence time between the end of the mixing section and where the radial flow was introduced into the bulk of the water was of the order of 0.025 seconds. In the improved eductor the time was of the order of 0.002 seconds. The shorter residence time in the improved eductor can therefore mean that the gas bubbles are unable to coalesce into larger bubbles and therefore remain relatively small in size. In the second common practice described above, it is clear that the residence time is further extended beyond that of the first common practice because the mixture of gas and water exiting the eductor additionally flows some distance in a pipe before being dispersed in the liquid in the cell. The second common practice is also found to produce a larger bubble size than the improved eductor.

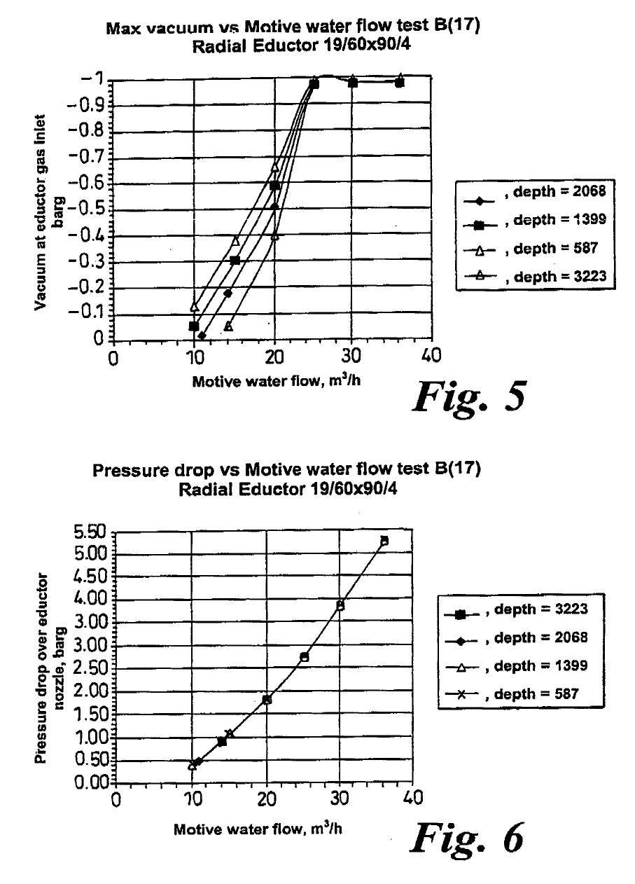

FIGS. 5 to 8 are graphs showing the test results of an improved eductor 900 shown partially in FIG. 9. The diameter of the aperture at the lower end of the nozzle 904 through which the jet of liquid is produced is 19 mm. The distance (defining the mixing and diffusing section 903) between the end face 910 of the eductor collar component 907 and the impingement plate 914 is 4 mm. The distance between the lower end of the nozzle 904 and the end face 910 is 107 mm.

The angle between the vertical and the side wall of the frusto conical upper inlet portion 907A of the eductor collar component 907 is 16°. An intermediate portion 907B of the collar 907 where the side walls are substantially vertical has a length of 10 mm. The minimum radius of the lower flared outlet portion 907C is 10 mm. The minimum diameter where the end face 910 first becomes parallel to the eductor component 907 is 90 mm.

For the results of FIGS. 5 to 7, the eductor 900 was tested at depths of 2068, 1399, 587 and 3223 millimeters. Referring first to FIG. 5, the Y-axis of the graph represents the maximum vacuum (in barg) at the gas inlet 102/402 and the X-axis represents the motive flow of the water (in m³/h) entering through the liquid inlet port 101/401.

In the graph of FIG. 6, the Y-axis represents the pressure drop (in barg) over the eductor nozzle 104/404 and the X-axis represents the motive water flow (in m³/h) through the chamber.

The Y-axis of the graph of FIG. 7 represents the entrained gas flow (i.e the bubbles emanating from the diffusing and mixing section 103/403) in m³/h, whilst its X-axis represents the motive water flow (in m³/h) at the liquid inlet 101/401.

The Y-axis of the graph of FIG. 8 also represents the entrained gas flow in m³/h. The X-axis of the graph represents the vacuum (in barg) at the gas inlet. The results shown were taken from an eductor at a depth of 1403 mm and having a motive water flow of 36 m³/h.

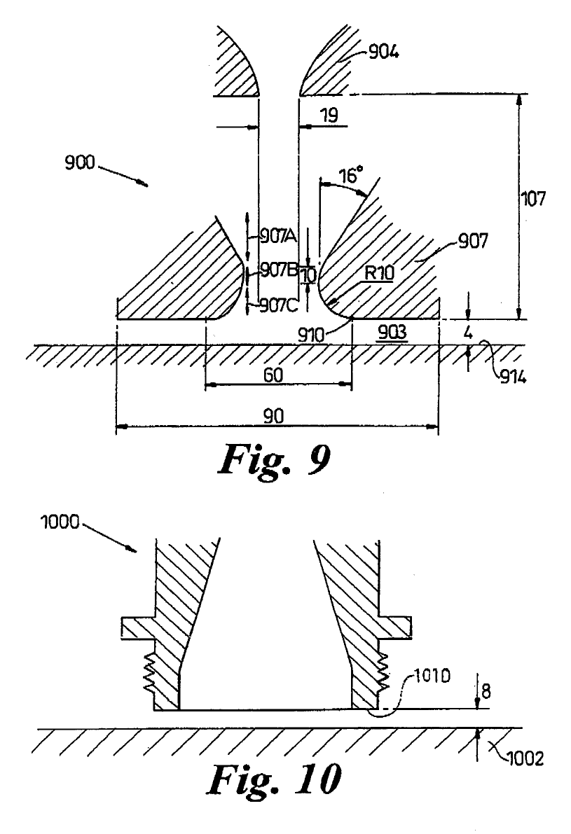

FIG. 10 shows the prior art eductor 1000 known as a Mazzei 2081-A with an impingement plate 1002 located 8 mm away from its end face 1010 so that the liquid/gas mixture exiting the eductor is initially dispersed substantially radially.

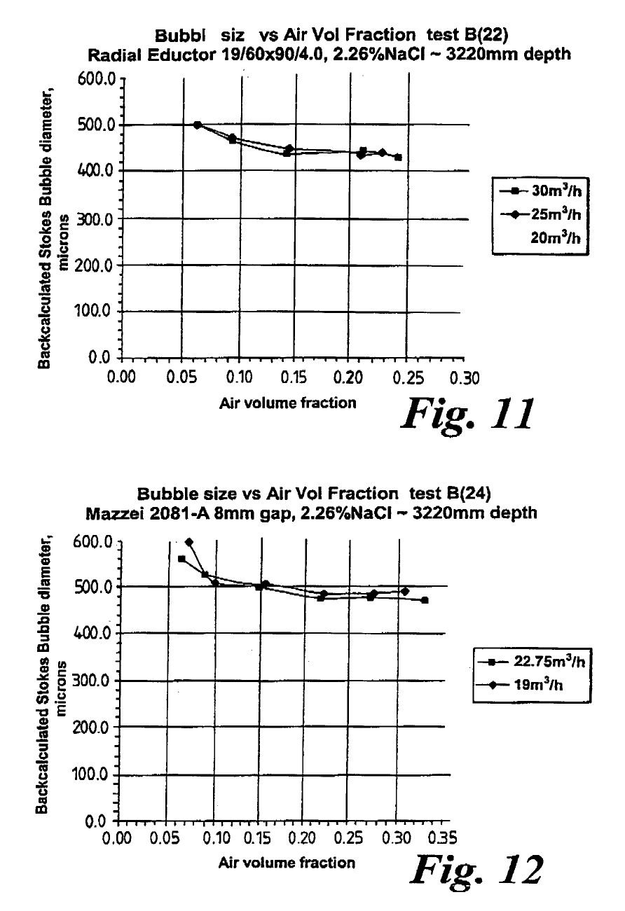

FIGS. 11 and 12 illustrate the bubble sizes produced by the eductors of FIGS. 9 and 10, respectively. Both eductors were tested at a depth of 3220 mm. The improved eductor 900 was tested with motive water flows of 30 m³/h, 25 m³/h and 20 m³/h. The prior art eductor 1000 was tested with motive water flows of 22.75 m³/h and 19 m³/h. The X-axes of the graphs represent the air volume fraction and Y-axes represent the Backcalculated Stokes Bubble diameter in microns.

The smaller bubbles and improved distribution of bubbles that can be produced by the various embodiments of the invention can be of use in processes other than separation of contaminants where mass transfer or a chemical reaction takes place between a gas and a liquid.

1. Eductor apparatus for introducing gas bubbles into a contaminated liquid in a gas flotation cell, the apparatus comprising an inlet port for clean liquid (as defined), the inlet port having an outlet end through which the clean liquid is ejected in a first direction, a gas inlet chamber adjacent to the outlet end of the inlet port for introducing gas to the liquid from a gas inlet port, the gas inlet chamber substantially surrounding the flow of liquid when the apparatus is in use, and a gas/liquid mixing and diffusing section wherein gas is entrained within the liquid prior to being ejected from the eductor into the contaminated liquid, the gas/liquid mixing and diffusing section having a direction of fluid flow substantially transverse to the first direction such that the fluid exits from the gas/liquid mixing and diffusing section substantially radially outwardly relative to said first direction.

2. Eductor apparatus according to claim 1 wherein the inner walls of the eductor beween the gas inlet chamber and the transition of fluid flow from the first direction to the second direction are curved towards the second direction, the curve providing a smooth change of direction of gas flow prior to the fluids entering the gas/liquid mixing and diffusing section.

3. Eductor apparatus according to claim 1 or claim 2, wherein the mixing and diffusing section is located at least partially in a space defined by an upper wall member adjacent to the gas inlet chamber and a lower wall member in the form of an impingement plate for the liquid disposed substantially opposite thereto.

4. Eductor apparatus according to any preceding Claim, wherein the mixing and diffusing section is generally annular.

5. Eductor apparatus according to claims 3 or 4 wherein the distance between the upper wall member and the impingement plate generally increases with increasing radial distance from the area of the impingement plate onto which the liquid flows from the first direction.

6. Eductor apparatus according to any one of claims 3 to 5 wherein the impingement plate is of greater diameter than the upper wall member.

7. Eductor apparatus according to any one of claims 2 to 6 wherein the impingement plate is provided with discontinuities on its surface for regulating the distribution of bubbles dissipating from the gas entrained liquid.

8. Eductor apparatus according to claim 7 wherein the discontinuities in the impingement plate are provided by apertures therein.

9. Eductor apparatus according to claim 7 wherein the discontinuities are provided by raised formations on said impingement plate.

10. A gas eductor induced air flotation separator including one or more gas introducing cells for bringing a gas into contact with a contaminated liquid, said separator including eductor apparatus according to any one of claims 1 to 9.

11. A gas eductor induced gas flotation separator including one or more gas introducing chambers for bringing a gas entrained liquid into contact with a contaminated liquid such as water by means of gas eductors, where contaminants in the liquid are floated to the surface of the liquid by attaching to gas bubbles emanating from said gas entrained liquid, each said eductor having a mixing and diffusing section substantially transverse to the axis of flow of the liquid entering the eductor, the eductor further including a channel section leading from the gas introducing chamber to the mixing and diffusion section, the channel section including:
an inlet portion adjacent to the gas introducing chamber;
an outlet portion adjacent to the mixing and diffusion section, and
an intermediate portion located between the inlet and outlet portions, the diameter of the intermediate portion being less than the diameter of the inlet portion, and the diameter of the outlet portion being greater than the diameter of the intermediate portion.

12. A separator according to claim 11, wherein the inner wall of the channel section between the inlet portion and the intermediate portion is substantially frusto-conical in shape.

13. A separator according to claim 11, wherein the inner wall of the channel section between the inlet portion and the intermediate portion is shaped substantially like an open end of a flared bell.

14. A separator according to any one of claims 11 to 13, wherein the inner wall of the channel section between the intermediate portion and the outlet portion is substantially frusto-conical in shape.

15. A separator according to any one of claims 11 to 13, wherein the inner wall of the channel section between the intermediate portion and the outlet portion is shaped substantially like the open end of a flared bell.

16. A separator according to any one of claims 11 to 15, wherein the mixing and diffusing section is located at least partially in a space defined by an outer surface of the outlet portion and an impingement plate fitted substantially transverse to the flow of liquid entering the eductor and adjacent the outlet portion.

17. A separator according to claim 16, wherein the mixing and diffusing space is generally annular.

18. A separator according to claim 16 or 17, wherein the impingement plate is fitted and spaced apart from the separator by a plurality of studs.

19. A separator according to claim 18, wherein the studs are fitted through a flange projecting from the channel section.

20. A separator according to any one of claims 16 to 19, wherein at least part of the outer surface of the outlet portion is cut away so that the distance between the outlet portion and the impingement plate is varied.

21. A separator according to any one of claims 16 to 20, wherein at least part of the surface of the impingement plate facing the outlet portion is cut away so that the distance between the outlet portion and the impingement plate is varied.

22. A separator according to claim 20 or 21, wherein the distance between the outlet portion and the impingement plate generally increases with increasing radial distance from the point on the impingement plate where the jet is directed.

23. Apparatus such as an eductor for mixing a gas with a liquid and diffusing the mixture in the form of bubbles, the apparatus including:
one or more gas introducing chambers for bringing a gas into contact with a liquid such as water;
a mixing and diffusing section substantially transverse to the axis of flow of the liquid entering the eductor, and
a channel section leading from the gas introducing chamber to the mixing and diffusion section, the channel section including:
an inlet portion:
an outlet portion adjacent to the mixing and diffusion section, and
an intermediate portion located between the inlet and outlet portions, the diameter of the intermediate portion being less than the diameter of the inlet portion, and the diameter of the outlet portion being greater than the diameter of the intermediate portion.

24. Apparatus according to claim 23, wherein the mixing and diffusing section is located at least partially in a space defined by an outer surface of the outlet portion and an impingement plate fitted substantially transverse to the flow of liquid through the eductor and adjacent the outlet portion.

25. Apparatus according to claim 23 or 24, further including a nozzle for receiving a flow of liquid entering the eductor and producing a jet, wherein the mixing and diffusing section is generally annular and has an outer diameter up to 15 times greater than the diameter of the jet issuing from the nozzle.

26. Apparatus according to claim 24, wherein the minimum diameter of the outlet portion where it becomes substantially parallel to the impingement plate is less than 2 times the diameter of the jet.

27. Apparatus according to claim 26, wherein the distance between the eductor outlet and the impingement plate is between 1.5 and 6 times the depth of the liquid at the periphery of a generally circular area of the plate substantially equal in diameter to the minimum diameter of the outlet portion where it becomes substantially parallel to the impingement plate.

28. Apparatus according to claim 27, wherein the depth of the liquid at the periphery of the generally circular area is calculated as: (diameter of jet)²/4×d1), where d1 is the minimum diameter of the outlet portion where it becomes substantially parallel to the impingement plate.

29. Apparatus for mixing a gas with a liquid and diffusing the mixture in the form of bubbles, the apparatus including:
a nozzle for receiving a flow of liquid entering the eductor and producing a jet of liquid;
one or more gas introducing chambers for bringing the gas into contact with the jet of liquid;
a mixing and diffusing section being substantially transverse to the axis of the liquid flow and being defined between an outlet portion of the eductor and a body spaced apart from the outlet portion, wherein the mixing and diffusing section is generally annular and has an outer diameter up to 15 times greater than the diameter of the jet issuing from the nozzle.

30. Apparatus according to claim 29, wherein the minimum diameter of the outlet portion where it becomes substantially parallel to the impingement plate is less than 2 times the diameter of the jet.

31. Apparatus according to claim 29 or 30, wherein the body includes an impingement plate and the distance between the eductor outlet and the impingement plate is between 1.5 and 6 times the depth of the liquid at the periphery of a generally circular area of the plate substantially equal in diameter to the minimum diameter of the outlet portion where it becomes substantially parallel to the impingement plate.

32. Apparatus according to claim 31, wherein the depth of the liquid on the generally circular area is calculated as: (diameter of jet)²/(4×d1), where d1 is the minimum diameter of the outlet portion where it becomes substantially parallel to the impingement plate.

33. A gas eductor substantially as hereinbefore described with reference to FIG. 2.

34. A gas eductor substantially as hereinbefore described with reference to FIG. 3.

35. A gas eductor substantially as hereinbefore described with reference to FIG. 4.

36. A gas eductor having a gas/liquid mixing and diffusing section substantially as hereinbefore described with reference to FIG. 9.

37. A gas eductor having a gas/liquid mixing and diffusing section substantially as hereinbefore described with reference to FIG. 10.
